(19) United States
(12) Patent Application Publication
(10) Pub. No.: US 2026/0080627 A1
(43) Pub. Date: Mar. 19, 2026

(54) REPROJECTION PLANE GENERATION USING DIGITAL EFFECT POSITIONING

(71) Applicant: Snap Inc., Santa Monica, CA (US)

(72) Inventors: Jan Bajana, Vienna (AT); Heinrich Fink, Vienna (AT); Dominik Schnitzer, Vienna (AT)

(21) Appl. No.: 18/884,549

(22) Filed: Sep. 13, 2024

(51) Int. Cl. G06T 19/00; G06F 3/01

(52) U.S. Cl. CPC G06T 19/00; G06F 3/011; G06T 2200/24; G06T 2219/008

(57) ABSTRACT

A system for presenting digital effects in a head-wearable apparatus is provided. The system generates, by a digital effect application, one or more digital effects for presentation on a digital effect display component and receives, by the digital effect display component, the one or more digital effects, the digital effect display component. The system receives, by the digital effect display component from the digital effect application, positioning information for the one or more digital effects in three-dimensional (3D) space. The system configures, by the digital effect display component, a two-dimensional (2D) re-projection plane based on the positioning information received from the digital effect application and displays, by the digital effect display component, the one or more digital effects on the 2D re-projection plane.

### TECHNICAL FIELD

Examples of the present disclosure relate generally to power attribution and throttling on mobile devices. More particularly, but not by way of limitation, examples of the present disclosure relate to a mobile device, such as a virtual reality (VR), mixed reality (MR), or an augmented reality (AR) mobile device where the VR, MR, or AR mobile device attributes power consumption and temperature generation to processes and throttles processes that exceed their power consumption or temperature generation budget.

### BACKGROUND

Users increasingly want mobile devices to operate in a more user-friendly manner with more functions. However, often, the mobile devices are susceptible to overheating and often the mobile devices have limited batteries to provide additional functions. Some wearable devices present virtual content but such content is susceptible to presentation errors as complexity of the underlying AR applications increases.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates an example digital effect presentation system, according to some examples.

FIG. 6 illustrates an example output of the digital effect presentation system, according to some examples.

FIG. 7 illustrates an example output of the digital effect creation system, according to some examples.

FIG. 8 illustrates a method performed by the digital effect presentation system, in accordance with some examples.

FIG. 9 illustrates a system in which the head-wearable apparatus can be implemented, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

The term mobile device is used as an illustrative device; however, one skilled in the art will recognize that the methods, systems, and computer readable medium disclosed herein are applicable to other mobile devices such as wearable devices or non-wearable devices including AR, VR and MR head-wearable devices (also referred to as digital effect creation and/or presentation applications, devices and/or systems).

AR applications have become increasingly prevalent across various industries, offering innovative solutions for visualization, training, and interactive experiences. As the demand for AR technology grows, organizations face challenges in efficiently scaling their AR operations to meet user needs. A common approach has been to scale all AR operations equally when usage exceeds certain thresholds or to scale certain AR operations. However, this uniform scaling strategy often leads to significant waste of resources and operational inefficiencies and the selection of which AR operations to scale is challenging.

In the realm of AR glasses, the interplay between the rendering component and the compositor component is important to consider for delivering a seamless and immersive experience. However, when these components operate at different frame rates, significant inefficiencies and resource wastage can occur, leading to various presentation errors. The rendering component, responsible for generating the AR content using an underlying AR application, typically operates at a lower frame rate than the compositor component due to the computational intensity of creating 3D imagery. This discrepancy in frame rates creates a fundamental challenge. By the time the compositor component receives a rendered image and presents the rendered image on a reprojection plane within lenses of the AR glasses, it may already be outdated relative to the user's current head position and orientation. This temporal mismatch can result in noticeable artifacts such as judder, where the AR content appears to stutter or jump as the user moves their head.

The reprojection plane is a virtual surface in 3D space onto which the rendered content is projected before being composited with the real-world view. The placement of this plane impacts the visual quality and stability of the AR content. When the compositor component uses a default position for the reprojection plane, it often leads to suboptimal results. This is because the ideal position for the reprojection plane varies depending on the content and its intended placement in the real world. If the plane is not aligned with the actual position of the AR content in space, several presentation errors can occur. When the reprojection plane is at an incorrect depth, the reprojected content may appear to jump or stutter as the user moves their head. This is because the content is being reprojected to an incorrect position in 3D space, causing it to move unnaturally relative to the real world. Content that is not aligned with the reprojection plane can become distorted during reprojection. For example, flat objects might appear to bend or warp, especially near the edges of the field of view. Incorrect placement of the reprojection plane can lead to conflicts between the perceived depth of the AR content and its intended position in the real world. This can break the illusion of the AR content being integrated into the environment. When the reprojection plane is significantly misaligned with the content's actual position, it can result in the appearance of multiple overlapping images or ghost images, such as during rapid head movements.

These errors are exacerbated by the frame rate discrepancy between the rendering and compositor components. The difference in frame rates can lead to a phenomenon known as double imaging. As the compositor component operates at a higher speed, it may project the same rendered image multiple times but in slightly different positions. This can create a ghosting effect, where the AR content appears to have multiple overlapping instances, significantly degrading the user experience. The inefficiency is compounded by the fact that the rendering component is expending resources to create images that may not be optimally used. Each rendered frame that fails to align perfectly with the user's current view represents wasted computational effort. This misalignment not only impacts visual quality but also increases power consumption, an important consideration for mobile AR devices.

To mitigate these issues, complex reprojection (re-projection) techniques are often employed. However, these techniques rely on accurate scene understanding and can introduce their own artifacts if not implemented correctly. The challenge lies in finding a balance between rendering frequency, compositor component speed, and reprojection accuracy to minimize latency and maintain visual stability without overtaxing the system's resources and wasting power.

The disclosed techniques address these and other challenges by providing a system that provides to the compositor component positioning information of digital effects. The compositor component can then dynamically adjust the reprojection plane used to display digital effects based on the positioning information to avoid presentation errors, such as judder. This way, the compositor component does not need to wait for updated 3D scene reconstructions to be generated and provided by the rendering component as the positioning information for previously generated 3D digital effects is available to be used to configure the projection plane. Specifically, the disclosed techniques generate, by a digital effect application (e.g., an AR application), one or more digital effects for presentation on a digital effect display component and receive, by the digital effect display component (e.g., the compositor component), the one or more digital effects. The disclosed techniques receive, by the digital effect display component from the digital effect application, positioning information for the one or more digital effects in three-dimensional (3D) space. The disclosed techniques configure, by the digital effect display component, a two-dimensional (2D) re-projection plane based on the positioning information received from the digital effect application and display, by the digital effect display component, the one or more digital effects on the 2D re-projection plane.

In this way, the disclosed techniques can present virtual content, such as digital effects (AR content) in a way that is free of presentation errors mentioned above. Also, by providing positioning information for the virtual content to the compositor component, the disclosed techniques can operate the rendering component at even lower frame rates to reduce power consumption or at higher frame rates to improve the quality of the presented content. This improves the overall efficiencies of operating the device and reduces the amount of resources needed to generate virtual content on a digital effect presentation system, such as AR glasses or other head-wearable apparatus.

### Networked Computing Environment

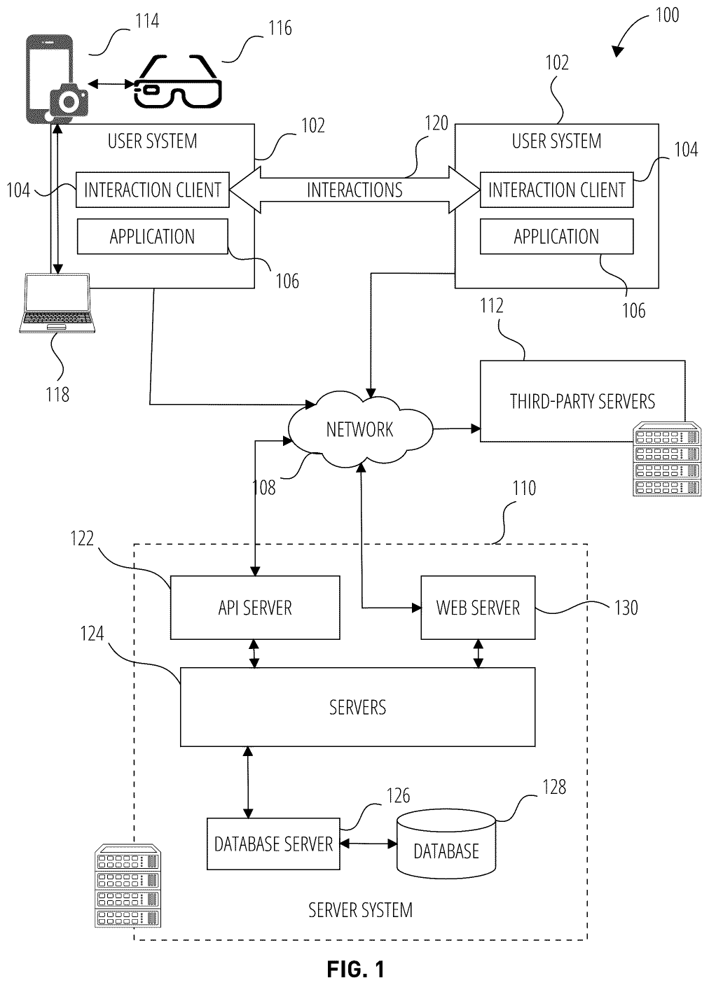

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 (e.g., an interaction application) and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112. An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

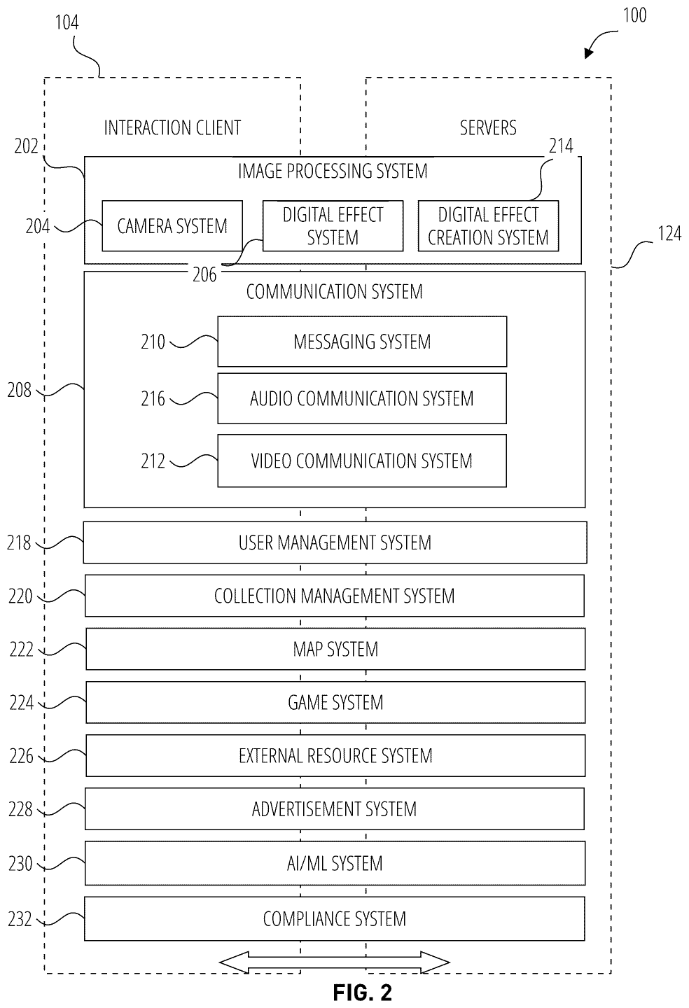

The servers 124 host multiple systems and subsystems, described below with reference to FIG. 2.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 (via a digital effect application which can be part of the interaction client 104) operatively selects, presents, and displays digital effects (e.g., media overlays such as image filters or modifications) to the interaction client 104 for the modification of real-time images received via the camera system 204 or stored images retrieved from memory 902 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

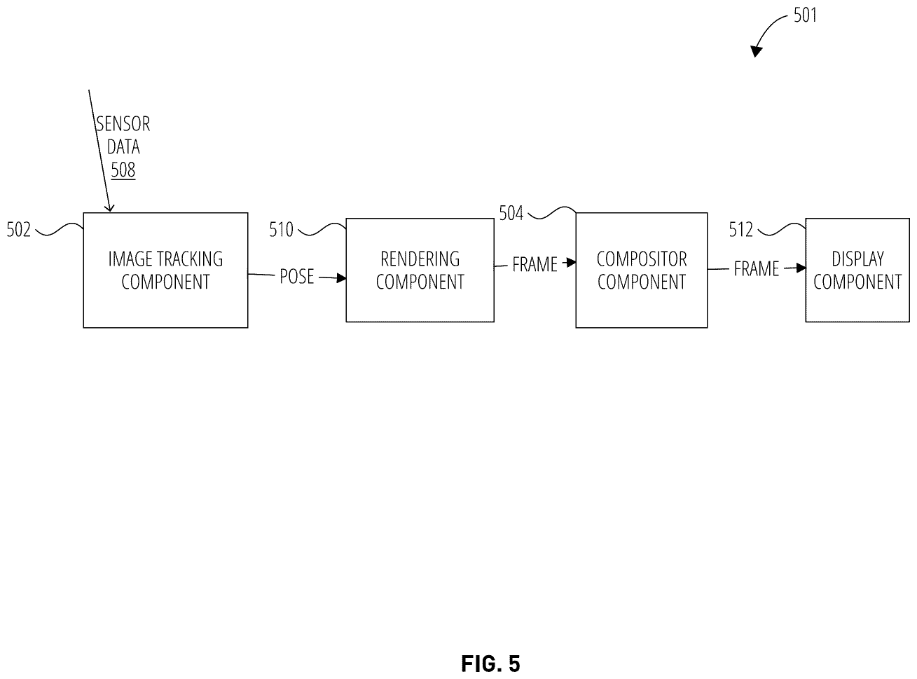

A digital effect presentation system 501 (FIG. 5) that embodies a digital effect application of the digital effect system 206 and a digital effect presentation component, such as AR glasses or other head-wearable apparatus 116. Details of the operation of the digital effect presentation system 501 are provided below.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates. The digital effect creation system 214 can be used by a developer to create a digital effect application for the digital effect presentation system 501.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

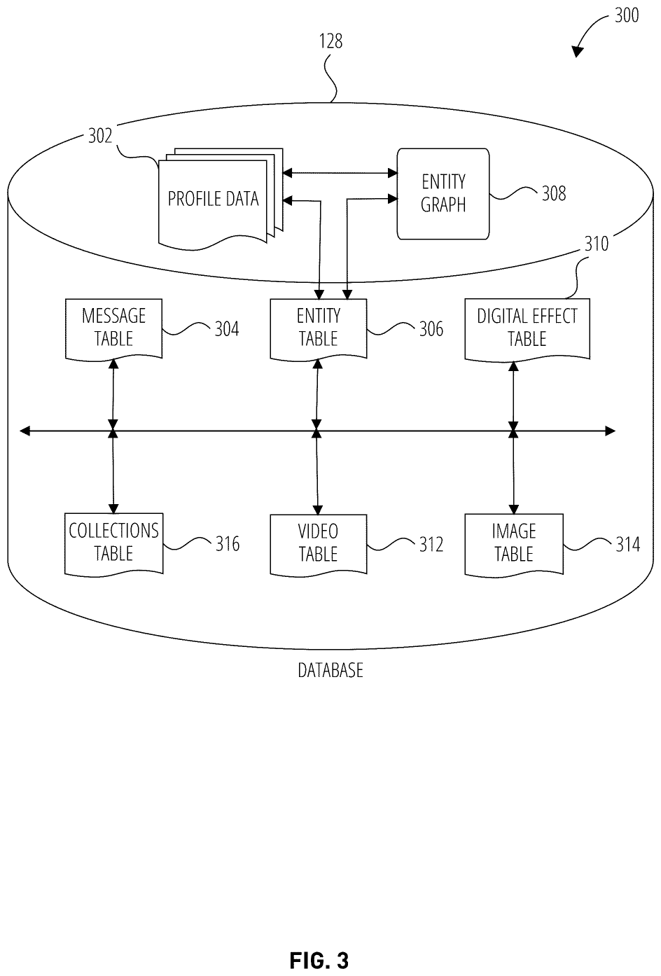

A user management system 218 is operationally responsible for the management of user data and profiles, and maintains entity information (e.g., stored in entity tables 306, entity graphs 308 and profile data 302, shown in FIG. 3) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional (2D) avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

### Data Communications Architecture

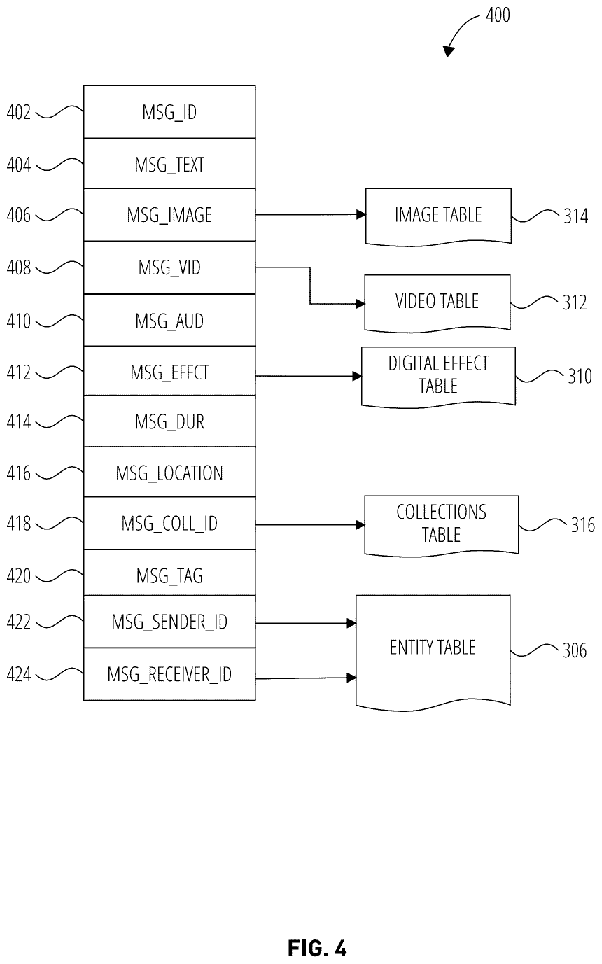

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

FIG. 5 illustrates an example digital effect presentation system 501, according to some examples. The digital effect presentation system 501 includes an image tracking component 502, a rendering component 510, a compositor component 504, and a display component 512. The digital effect presentation system 501 can be implemented at least in part on the interaction client 104. The digital effect presentation system 501 can run or execute a digital effect application (e.g., an AR application) on the user system 102 and can present one or more digital effects (e.g., AR content or virtual content) on a display (e.g., lenses of a head-wearable apparatus 116) of the digital effect presentation system 501.

The image tracking component 502 can collect sensor data 508 from the user system 102. The sensor data 508 can include any type of motion sensor, such as a gyroscope and/or accelerometer. The image tracking component 502 can generate Simultaneous Localization and Mapping (SLAM) information or data that enables the digital effect presentation system 501 to perceive a real-world environment and generate accurately a 3D scene that includes the digital effects. SLAM uses a camera and image recognition software to identify surfaces, and then maps out a space while keeping track of the device's location within that space. This allows the digital effect application to identify objects and images in the real world and project virtual content onto the AR displays, creating immersive and realistic experiences.

In some cases, the image tracking component 502 provides the SLAM information to the rendering component 510 and the compositor component 504. For example, the image tracking component 502 can compute a current pose of the user system 102 and provide the pose to the rendering component 510 and/or the compositor component 504.

The rendering component 510 can run or execute a digital effect application. The rendering component 510 in AR glasses is responsible for generating the virtual content that will be overlaid onto the real world. The rendering component 510 processes 3D models, textures, and other graphical elements to create realistic virtual objects that will be integrated into the user's view. The rendering component 510 applies various visual effects, including lighting and shading, to enhance the realism of the rendered content. The rendering component 510 may account for the specific characteristics of the AR display, such as field of view and color reproduction capabilities. The rendering component 510 generates content that will appear correctly when projected onto the user's view, taking into consideration factors like lens distortion and the blending of virtual and real-world elements. In some examples, the rendering component 510 operates at a first frame rate of 60 Hz. This first frame rate can be dynamically adjustable based on various conditions, such as power consumption and/or high resolution/frame rate situations.

The rendering component 510 generates frames based on the most recent data available about the user's position and orientation received from the image tracking component 502. In some cases, due to its lower operational speed, by the time a frame is completed by the rendering component 510 and passed to the compositor component 504, it may already be outdated relative to the user's current head position. In some examples, the rendering component 510 generates a 3D scene that includes a plurality of digital effects. The rendering component 510 can process user inputs to detect and/or identify a particular set of digital effects (e.g., one or more digital effects) that are currently in focus. The set of digital effects can include digital effects that are currently selected and/or highlighted and/or being looked at by the user. In some cases, the rendering component 510 can send a message to the compositor component 504 that indicates and/or identifies the set of digital effects that are currently in focus relative to other digital effects that are part of the 3D scene. This information is provided in a 3D frame to the compositor component 504.

The compositor component 504 receives the information about the 3D scene from the rendering component 510. The compositor component 504 includes a warping component and a 2D buffer. The compositor component 504 processes the information and configures a 2D reprojection plane at a particular position in 3D space. The compositor component 504 places the digital effects receives from the rendering component 510 on the 2D reprojection plane. The compositor component 504 can generate a frame that includes the digital effects at a second frame rate (e.g., 120 Hz) and provides that frame to the display component 512. The display component 512 can include a physical display, such as lenses or a head-wearable apparatus 116 that present the digital effects.

The compositor component 504 in AR glasses plays an important role in combining rendered virtual content with the real-world view and ensuring smooth, low-latency output to the display component 512. Operating at a higher frame rate than the rendering component 510, the compositor receives rendered frames and applies various transformations to integrate them seamlessly with the user's view. A key function of the compositor component 504 is reprojection, which involves adjusting the rendered content based on the most up-to-date head position data received from the image tracking component 502 (e.g., using the SLAM information). This process utilizes a reprojection plane, a virtual surface in 3D space onto which the rendered content is projected. The compositor applies homographic transformations to warp the image according to the difference between the head position at render time and the current head position. The compositor component 504 also handles optical corrections, compensating for lens distortions and other characteristics specific to the AR glasses'display system. It sends the final output to the display component 512, ensuring that the virtual content appears correctly aligned and integrated with the real world. This process involves precise timing and synchronization to maintain low latency and prevent visual inconsistencies.

The placement of the reprojection plane is important for minimizing visual artifacts. Ideally, the reprojection plane should align with the intended position of the virtual content in the real world. However, when the compositor component 504 uses a default position for this plane, it can lead to various presentation errors, such as when the content's actual position differs significantly from the default. By operating in 2D, the compositor component 504 can efficiently apply these transformations and corrections, optimizing performance and reducing latency. This approach allows for rapid processing of each frame, important for maintaining a smooth and responsive AR experience, such as during fast head movements.

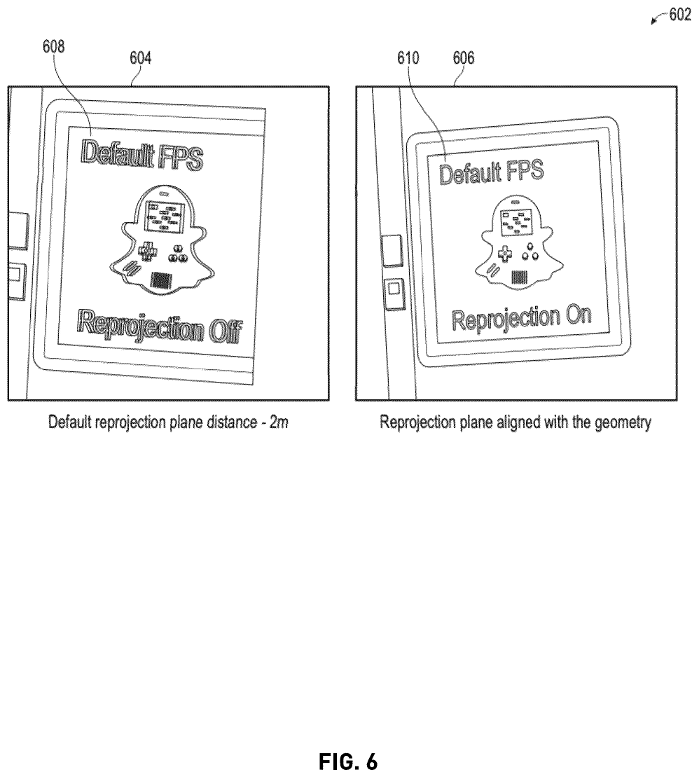

For example, as shown in the diagram 602 of FIG. 6, the compositor component 504 can present a display 604 that includes a frame with one or more digital effects 608. When the reprojection plane used by the compositor component 504 is set to a default value (e.g., 2 meters away from the display component 512), the one or more digital effects 608 are susceptible to presentation errors, such as judder effects. This is due to the fact that rapid movement of the AR glasses can cause the compositor component 504 to present the one or more digital effects 608 at a position that has yet to be updated by the rendering component 510. Namely, the one or more digital effects 608 can be incorrectly positioned, which can appear to the user as judder or ghosting.

In order to properly account for these presentation errors, in some examples, the compositor component 504 can receive positioning information from the digital effect application. In some cases, the positioning information includes a transformation matrix. In such cases, the compositor component 504 computes or configures the reprojection frame at a particular placement based on the transformation matrix.

The positioning information can identify the one or more digital effects 608 that are currently in focus and can provide a point in the real-world environment and normal (e.g., surface normal) of the one or more digital effects 608. This positioning information represents the orientation of the one or more digital effects 608, which can be used to properly configure placement of the reprojection plane. In some examples, the compositor component 504 configures placement of the reprojection plane for one or more digital effects 608 received in a previous frame from the rendering component 510 using the SLAM information and using the positioning information received from the rendering component 510. When the compositor component 504 properly computes and configures placement of the reprojection plane, the compositor component 504 can generate a display 606 where the one or more digital effects 610 are presented with minimal presentation errors or no presentation errors at all. This is because the one or more digital effects 610 are aligned with the geometry specified by the digital effect application even while the compositor component 504 operates at a higher frame rate than the frame rate of the rendering component 510. In some cases, the compositor component 504 can only modify the position of the reprojection plane for the digital effects that are in focus based on the positioning information of those digital effects. Other digital effects that are included in a particular frame being displayed and that are not in focus can be presented on a reprojection plane that is placed at a default position.

In some examples, the rendering component 510 can monitor conditions for adjusting the frame rate of the rendering component 510. For example, the rendering component 510 can determine that a condition for reduced power consumption is currently satisfied. In response, the rendering component 510 can reduce the frame rate at which the rendering component 510 generates the 3D scene information from the first frame rate to a third frame rate (e.g., from 60 Hz to 30 Hz). The compositor component 504 can continue operating at the second frame rate (e.g., 120 Hz) without affecting or introducing errors in the presented digital effects because the compositor component 504 configures the reprojection plane using the positioning information received from rendering component 510.

In some cases, the rendering component 510 can determine that a condition for increased frame rate is being met. In such cases, the rendering component 510 can increase the frame rate at which the rendering component 510 generates the 3D scene information from the first frame rate to a third frame rate (e.g., from 60 Hz to 90 Hz or 120 Hz). The compositor component 504 can continue operating at the second frame rate (e.g., 120 Hz) without affecting or introducing errors in the presented digital effects because the compositor component 504 configures the reprojection plane using the positioning information received from rendering component 510.

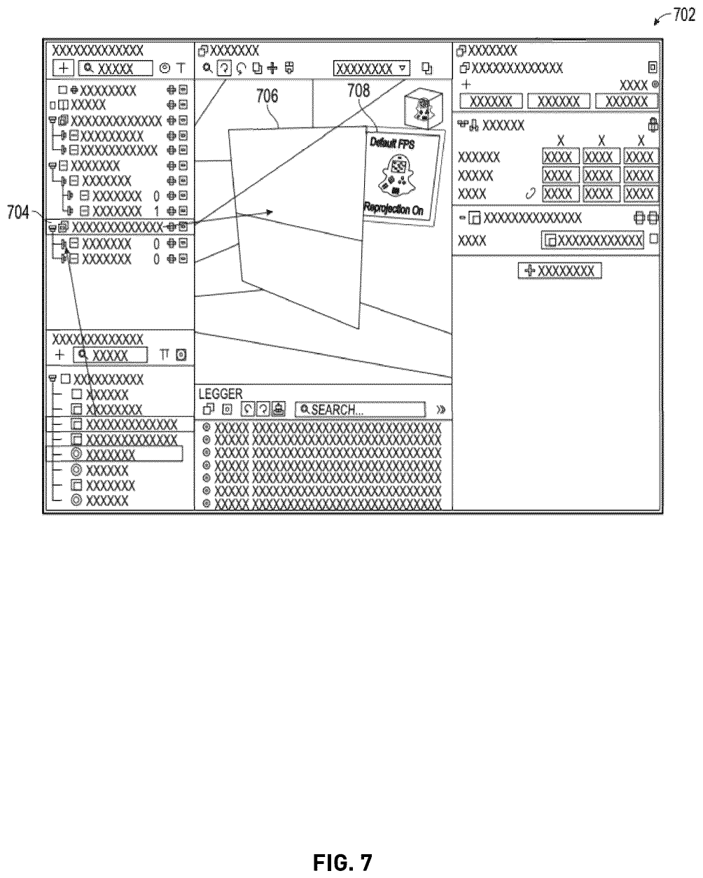

FIG. 7 illustrates an example output of the digital effect creation digital effect presentation system 501, according to some examples. In particular, the digital effect presentation system 501 can implement the digital effect application that has been developed by a developer. The digital effect application can be developed using a digital effect creation system 214. The developer can be presented with a graphical user interface 702. Through the graphical user interface 702, the developer can specify various configuration information for the digital effect application. For example, the graphical user interface 702 can receive inputs from the developer that specifies different conditions under which the frame rate of the rendering component 510 is adjusted. Specifically, the developer can specify that when a request is received to operate the digital effect application at a lower power, the frame rate of the rendering component 510 is adjusted to a lower value (e.g., reduced from 60 Hz to 30 Hz).

Similarly, the developer can specify that when a request is received to operate the digital effect application at a higher frame rate, the frame rate of the rendering component 510 is adjusted to a higher value (e.g., increased from 60 Hz to 90 Hz or 120 Hz). The developer can specify the condition as being a particular type of real-world object in view or when a particular digital effect is currently in focus. For example, the developer can associate different digital effects with different frame rates of the rendering component 510. When a first digital effect is determined to be in focus, the developer can specify in the configuration data to operate the rendering component 510 at a particular frame rate (e.g., 60 Hz). When focus is shifted to a second digital effect, the developer can specify in the configuration data to operate the rendering component 510 at a different frame rate (e.g., 90 Hz).

The graphical user interface 702 can present a target re-projection plane option 704. The target re-projection plane option 704 can allow the developer to specify the real-world coordinate or point and the surface normal of the target reprojection frame. In some cases, the target re-projection plane option 704 can enable the developer to specify a transformation matrix that is used by the compositor component 504 to configure the reprojection frame. In response to receiving input that specifies the orientation and/or positioning information for the reprojection frame based on the target re-projection plane option 704, the graphical user interface 702 presents a target re-projection plane 706 and the one or more digital effects 708. This allows the developer to visualize where the target re-projection plane 706 will be placed by the rendering component 510 relative to the placement of the one or more digital effects 708. The graphical user interface 702 can allow the developer to adjust the positioning of the target re-projection plane 706, such as by dragging and dropping the target re-projection plane 706 to different positions. The graphical user interface 702 then stores the last position of the target re-projection plane 706 as the positioning information that is provided to the rendering component 510 when rendering or operating the digital effect application.

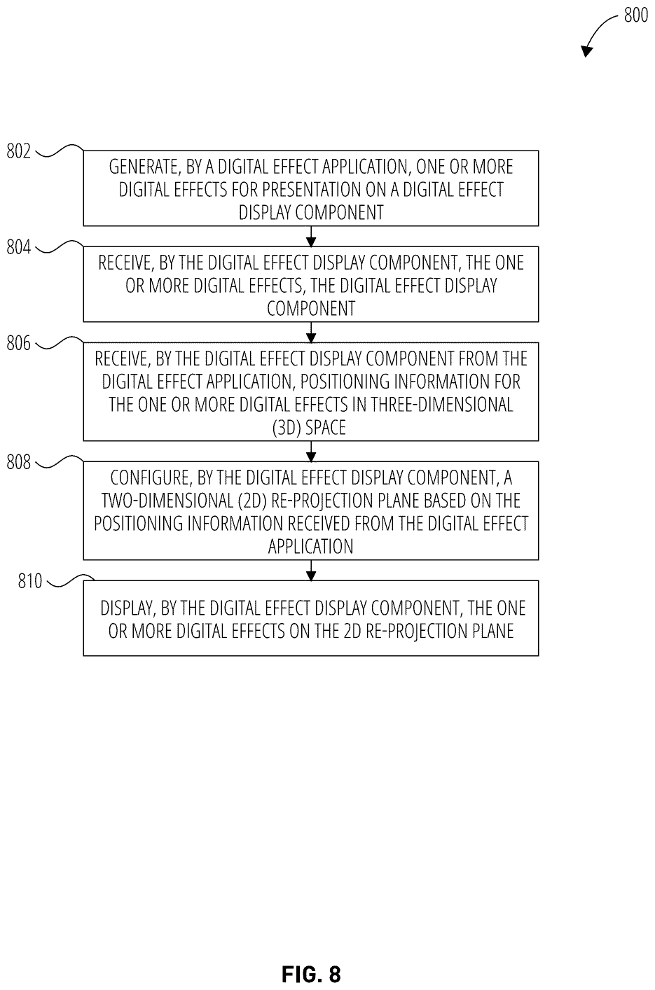

FIG. 8 illustrates a method 800 (or process) performed by the digital effect presentation system 501, in accordance with some examples. The method 800 may optionally include one or more additional operations. The operations of method 800 may be performed in a different order. One or more of the operations of method 800 may be optional.

The method 800 can perform various operations. For example, in operation 802 the method 800 can generate, by a digital effect application, one or more digital effects for presentation on a digital effect display component, as discussed above.

In operation 804, method 800 receives, by the digital effect display component, the one or more digital effects, the digital effect display component, as discussed above.

In operation 806, method 800 receives, by the digital effect display component from the digital effect application, positioning information for the one or more digital effects in three-dimensional (3D) space, as discussed above.

In operation 808, method 800 configures, by the digital effect display component, a two-dimensional (2D) re-projection plane based on the positioning information received from the digital effect application, as discussed above.

In operation 810, method 800 displays, by the digital effect display component, the one or more digital effects on the 2D re-projection plane, as discussed above.

### System With Head-Wearable Apparatus

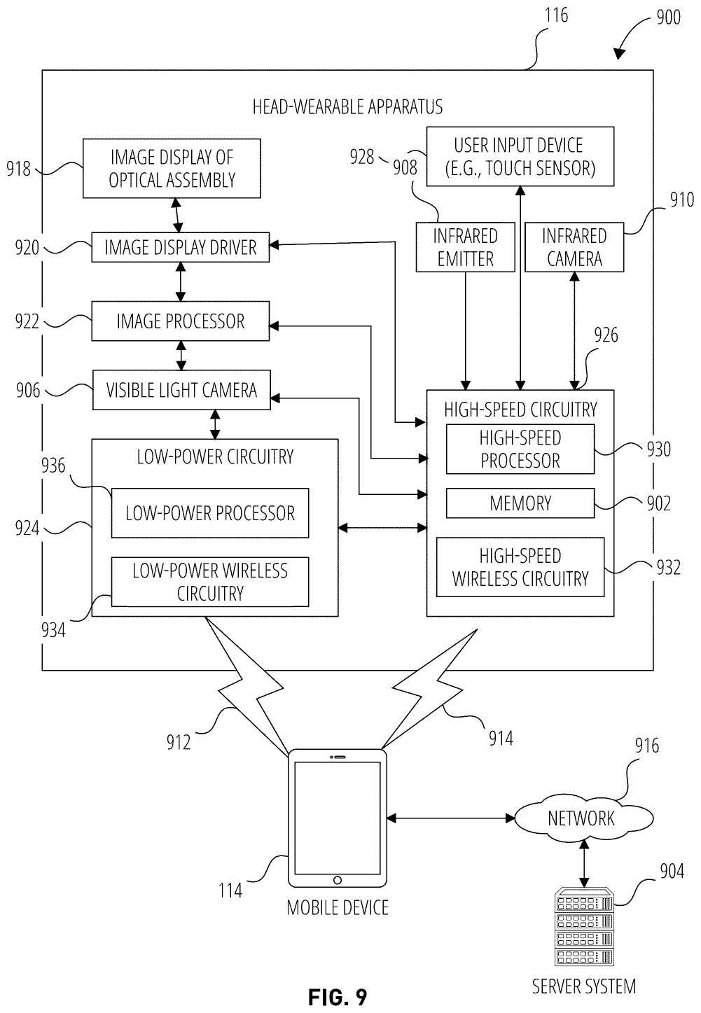

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110) via various networks 108.

The head-wearable apparatus 116 includes one or more cameras, each of which may be, for example, a visible light camera 906, an infrared emitter 908, and an infrared camera 910. In some cases, the head-wearable apparatus 116 includes a digital effect display component including the image display of optical assembly 918 or other digital effect presentation systems.

The mobile device 114 connects with head-wearable apparatus 116 using both a low-power wireless connection 912 and a high-speed wireless connection 914. The mobile device 114 is also connected to the server system 904 and the Network 916.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image Processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed Processor 930, a memory 902, and high-speed wireless circuitry 932. In some examples, the image display driver 920 is coupled to the high-speed circuitry 926 and operated by the high-speed Processor 930 to drive the left and right image displays of the image display of optical assembly 918. The high-speed Processor 930 may be any processor capable of managing high-speed communications and operation of any general computing system needed for the head-wearable apparatus 116. The high-speed Processor 930 includes processing resources needed for managing high-speed data transfers on a high-speed wireless connection 914 to a wireless local area network (WLAN) using the high-speed wireless circuitry 932. In certain examples, the high-speed Processor 930 executes an operating system such as a LINUX operating system or other such operating system of the head-wearable apparatus 116, and the operating system is stored in the memory 902 for execution. In addition to any other responsibilities, the high-speed Processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the Network 916.

The memory 902 includes any storage device capable of storing various data and applications, including, among other things, camera data generated by the left and right visible light cameras 906, the infrared camera 910, and the image Processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed Processor 930 from the image Processor 922 or the low-power Processor 936 to the memory 902. In some examples, the high-speed Processor 930 may manage addressing of the memory 902 such that the low-power Processor 936 will boot the high-speed Processor 930 any time that a read or write operation involving memory 902 is needed.

As shown in FIG. 9, the low-power Processor 936 or high-speed Processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the Network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a Network communication interface coupled to the processor. The Network communication interface allows for communication over the Network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

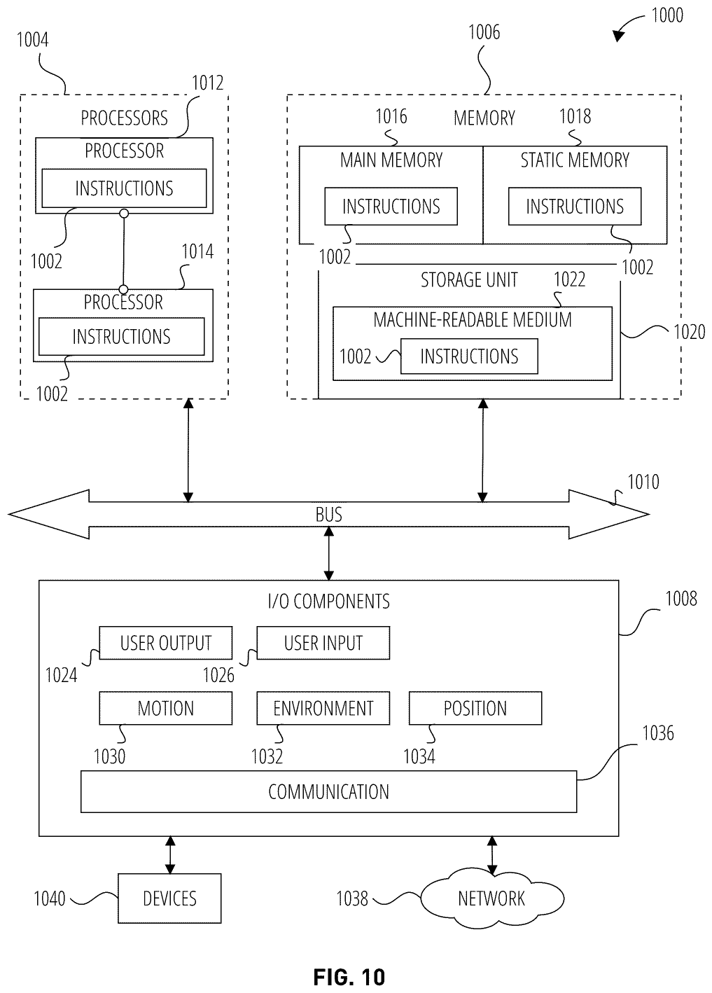

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024, position components 1034, and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 1030 include acceleration sensor components (e.g., accelerometer), gravitation sensor components, and rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a Network 1038 or devices 1040 via respective coupling or connections. For example, the communication components 1036 may include a network interface component or another suitable device to interface with the Network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the Network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

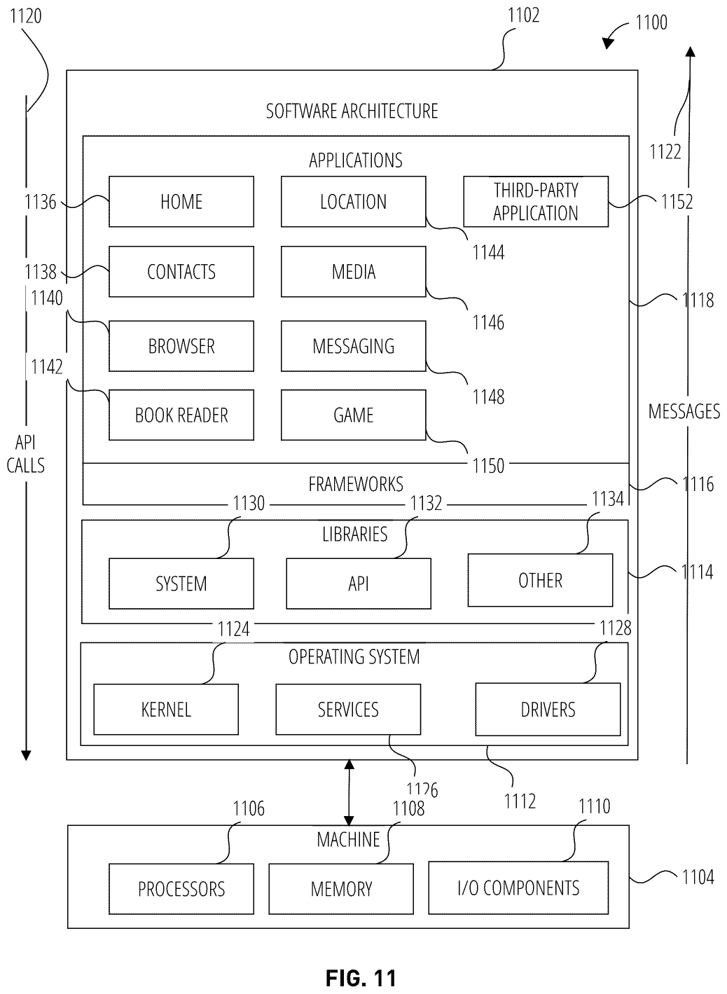

FIG. 11 is a block diagram 1100 illustrating a software architecture 1102, which can be installed on any one or more of the devices described herein. The software architecture 1102 is supported by hardware such as a machine 1104 that includes Processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an Open GL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

The above description is intended to be illustrative, and not restrictive. For example, the above-described examples (or one or more aspects thereof) can be used in combination with others. Other examples can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein, as examples can feature a subset of said features. Further, examples can include fewer features than those disclosed in a particular example. Thus, the following claims are hereby incorporated into the Detailed Description, with each claim standing on its own as a separate example. The scope of the examples disclosed herein is to be determined with reference to the appended claims, along with the full scope of equivalents to which such claims are entitled.

### EXAMPLE STATEMENTS

Example 1. A system comprising: at least one processor; at least one memory component storing instructions that, when executed by the at least one processor, cause the at least one processor to perform operations comprising: generating, by a digital effect application, one or more digital effects for presentation on a digital effect display component; receiving, by the digital effect display component, the one or more digital effects, the digital effect display component; receiving, by the digital effect display component from the digital effect application, positioning information for the one or more digital effects in three-dimensional (3D) space; configuring, by the digital effect display component, a two-dimensional (2D) re-projection plane based on the positioning information received from the digital effect application; and displaying, by the digital effect display component, the one or more digital effects on the 2D re-projection plane.

Example 2. The system of Example 1, wherein the digital effect application comprises at least one of an augmented reality (AR) application or virtual reality (VR) application.

Example 3. The system of any one of Examples 1-2, wherein the digital effect display component is included as part of a head-wearable apparatus.

Example 4. The system of any one of Examples 1-3, wherein the digital effect application is part of an interaction application being executed on a user device, the operations comprise: receiving, by the digital effect display component, tracking information from one or more sensors of the user device, the tracking information representing movement of the user device in 3D space; and configuring the 2D re-projection plane based on the positioning information and the tracking information.

Example 5. The system of any one of Examples 1-4, wherein the digital effect application comprises a rendering component, and wherein the digital effect display component comprises a compositor component.

Example 6. The system of Example 5, wherein the operations comprise: processing, by the rendering component, pose information associated with a user device and data of the digital effect application to generate a 3D scene comprising the one or more digital effects, the processing of the pose information and the data being performed at a first frame rate; and processing, by the compositor component, the 3D scene to generate the one or more digital effects in the 2D re-projection plane at a second frame rate, the second frame rate being different from the first frame rate, wherein the digital effect application positions the 2D re-projection plane in order to remove artifacts of a reduced frame rate mode in which the 3D scene is generated at the first frame rate.

Example 7. The system of Example 6, wherein the second frame rate at which the one or more digital effects are generated in the 2D re-projection plane is double the first frame rate at which the 3D scene is generated.

Example 8. The system of any one of Examples 6-7, wherein the operations comprise: determining a condition for adjusting the first frame rate; and modifying the first frame rate in response to determining the condition.

Example 9. The system of Example 8, wherein the condition comprises receiving a request to operate a user device at reduced power, and wherein the operations comprise: in response to receiving the request to operate the user device at the reduced power, reducing the first frame rate to a third frame rate.

Example 10. The system of any one of Examples 8-9, wherein the condition comprises receiving a request to operate a user device at a high frame rate, and wherein the operations comprise: in response to receiving the request to operate the user device at the high frame rate, increasing the first frame rate to a third frame rate.

Example 11. The system of any one of Examples 1-10, wherein the positioning information comprises orientation of the one or more digital effects comprising a point in 3D space and a normal of the one or more digital effects.

Example 12. The system of any one of Examples 1-11, wherein the positioning information comprises a transformation matrix representing orientation of the one or more digital effects.

Example 13. The system of any one of Examples 1-12, wherein the operations comprise: detecting a plurality of digital effects in a 3D scene generated by the digital effect application, the plurality of digital effects comprising the one or more digital effects; determining that the one or more digital effects are currently in focus; and providing an indication to the digital effect display component specifying that the one or more digital effects are currently in focus.

Example 14. The system of Example 13, wherein the 2D re-projection plane is generated based on the positioning information associated with the one or more digital effects that are currently in focus, and wherein 2D re-projection planes associated with a remaining portion of the plurality of digital effects are configured using default positioning information.

Example 15. The system of any one of Examples 1-14, wherein the digital effect application is generated by a digital effect creation system comprising a digital effect creation application, and wherein the digital effect creation application is configured to perform operations comprising: presenting a graphical user interface (GUI) to a developer of the digital effect application; and receiving, via the GUI, input from the developer that specifies a position for a target 2D re-projection plane associated with the one or more digital effects.

Example 16. The system of Example 15, wherein the digital effect creation application displays, in the GUI, a visual representation of the target 2D re-projection plane together with the one or more digital effects.

Example 17 is an apparatus comprising means to implement of any of Examples 1-16.

Example 18 is a system to implement of any of Examples 1-16.

Example 19 is a non-transitory computer readable medium with instructions, executed by one or more processors, to cause the one or more processors to implement of any of Examples 1-16.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
generating, by a digital effect application, one or more digital effects for presentation on a digital effect display component;
receiving, by the digital effect display component, the one or more digital effects, the digital effect display component;
receiving, by the digital effect display component from the digital effect application, positioning information for the one or more digital effects in three-dimensional (3D) space;
configuring, by the digital effect display component, a two-dimensional (2D) re-projection plane based on the positioning information received from the digital effect application; and
displaying, by the digital effect display component, the one or more digital effects on the 2D re-projection plane.

2. The system of claim 1, wherein the digital effect application comprises at least one of an augmented reality (AR) application or virtual reality (VR) application.

3. The system of claim 1, wherein the digital effect display component is included as part of a head-wearable apparatus.

4. The system of claim 1, wherein the digital effect application is part of an interaction application being executed on a user device, the operations comprise:
receiving, by the digital effect display component, tracking information from one or more sensors of the user device, the tracking information representing movement of the user device in 3D space; and
configuring the 2D re-projection plane based on the positioning information and the tracking information.

5. The system of claim 1, wherein the digital effect application comprises a rendering component, and wherein the digital effect display component comprises a compositor component.

6. The system of claim 5, wherein the operations comprise:
processing, by the rendering component, pose information associated with a user device and data of the digital effect application to generate a 3D scene comprising the one or more digital effects, the processing of the pose information and the data being performed at a first frame rate; and
processing, by the compositor component, the 3D scene to generate the one or more digital effects in the 2D re-projection plane at a second frame rate, the second frame rate being different from the first frame rate, wherein the digital effect application positions the 2D re-projection plane in order to remove artifacts of a reduced frame rate mode in which the 3D scene is generated at the first frame rate.

7. The system of claim 6, wherein the second frame rate at which the one or more digital effects are generated in the 2D re-projection plane is double the first frame rate at which the 3D scene is generated.

8. The system of claim 6, wherein the operations comprise:
determining a condition for adjusting the first frame rate; and
modifying the first frame rate in response to determining the condition.

9. The system of claim 8, wherein the condition comprises receiving a request to operate the user device at reduced power, and wherein the operations comprise:
in response to receiving the request to operate the user device at the reduced power, reducing the first frame rate to a third frame rate.

10. The system of claim 8, wherein the condition comprises receiving a request to operate the user device at a high frame rate, and wherein the operations comprise:
in response to receiving the request to operate the user device at the high frame rate, increasing the first frame rate to a third frame rate.

11. The system of claim 1, wherein the positioning information comprises orientation of the one or more digital effects comprising a point in 3D space and a normal of the one or more digital effects.

12. The system of claim 1, wherein the positioning information comprises a transformation matrix representing orientation of the one or more digital effects.

13. The system of claim 1, wherein the operations comprise:
detecting a plurality of digital effects in a 3D scene generated by the digital effect application, the plurality of digital effects comprising the one or more digital effects;
determining that the one or more digital effects are currently in focus; and
providing an indication to the digital effect display component specifying that the one or more digital effects are currently in focus.

14. The system of claim 13, wherein the 2D re-projection plane is generated based on the positioning information associated with the one or more digital effects that are currently in focus, and wherein 2D re-projection planes associated with a remaining portion of the plurality of digital effects are configured using default positioning information.

15. The system of claim 1, wherein the digital effect application is generated by a digital effect creation system comprising a digital effect creation application, and wherein the digital effect creation application is configured to perform operations comprising:
presenting a graphical user interface (GUI) to a developer of the digital effect application; and
receiving, via the GUI, input from the developer that specifies a position for a target 2D re-projection plane associated with the one or more digital effects.

16. The system of claim 15, wherein the digital effect creation application displays, in the GUI, a visual representation of the target 2D re-projection plane together with the one or more digital effects.

17. A method comprising:
generating, by a digital effect application, one or more digital effects for presentation on a digital effect display component;
receiving, by the digital effect display component, the one or more digital effects, the digital effect display component;
receiving, by the digital effect display component from the digital effect application, positioning information for the one or more digital effects in three-dimensional (3D) space;
configuring, by the digital effect display component, a two-dimensional (2D) re-projection plane based on the positioning information received from the digital effect application; and
displaying, by the digital effect display component, the one or more digital effects on the 2D re-projection plane.

18. The method of claim 17, wherein the digital effect application comprises at least one of an augmented reality (AR) application or virtual reality (VR) application.

19. The method of claim 17, wherein the digital effect display component is included as part of a head-wearable apparatus.

20. A non-transitory computer-readable storage medium storing instructions that, when executed by at least one processor, cause the at least one processor to perform operations comprising:
generating, by a digital effect application, one or more digital effects for presentation on a digital effect display component;
receiving, by the digital effect display component, the one or more digital effects, the digital effect display component;
receiving, by the digital effect display component from the digital effect application, positioning information for the one or more digital effects in three-dimensional (3D) space;
configuring, by the digital effect display component, a two-dimensional (2D) re-projection plane based on the positioning information received from the digital effect application; and
displaying, by the digital effect display component, the one or more digital effects on the 2D re-projection plane.
